(19) United States
(12) Patent Application Publication
(10) Pub. No.: US 2020/0269793 A1
(43) Pub. Date: Aug. 27, 2020

(54) APPARATUS AND METHOD FOR DETECTING IMPACT PORTION IN VEHICLE

(71) Applicants: HYUNDAI MOTOR COMPANY, Seoul (KR); KIA MOTORS CORPORATION, Seoul (KR)

(72) Inventor: Sung Hwan JUN, Hwaseong-si (KR)

(21) Appl. No.: 16/433,728

(22) Filed: Jun. 6, 2019

(30) Foreign Application Priority Data
Feb. 22, 2019 (KR) 10-2019-0021160

(51) Int. Cl. B60R 21/0136; H04N 5/247; H04N 7/18; G08G 1/16; G08B 5/22

(52) U.S. Cl. CPC B60R 21/0136; H04N 5/247; G08B 5/223; G08G 1/162; H04N 7/181

(57) ABSTRACT

An apparatus for detecting an impact portion in a vehicle includes: an impact sensor configured to measure a time domain value which corresponds to an impact applied to the vehicle; and a controller configured to convert the time domain value into a frequency domain value and to detect at least one impact portion of the vehicle based on a frequency characteristic of the impact.

### CROSS-REFERENCE TO RELATED APPLICATION

This application claims the benefit of priority to Korean Patent Application No. 10-2019-0021160, filed in the Korean Intellectual Property Office on Feb. 22, 2019, the entire contents of which are incorporated herein by reference.

### TECHNICAL FIELD

The present disclosure relates to detecting an impact portion when an impact of greater than or equal to a reference value is applied to a vehicle.

### BACKGROUND

In general, an apparatus for detecting an impact portion in a vehicle has at least one camera which captures an image outside the vehicle. The apparatus detects an impact direction (a front/rear direction, a left/right direction, or an upward/downward direction) of the vehicle based on a value measured by an impact sensor (e.g., a three-axis acceleration sensor) according to an impact applied to the vehicle and detects the impact portion of the vehicle based on the image captured by the camera located in the impact direction of the vehicle.

Such a conventional apparatus for detecting an impact portion in a vehicle can detect only the impact direction of the vehicle using the impact sensor, however cannot detect the impact portion of the image without the image captured by the camera.

### SUMMARY

The present disclosure has been made to solve the above-mentioned problems occurring in the prior art while advantages achieved by the prior art are maintained intact.

An aspect of the present disclosure provides an apparatus and method for detecting an impact portion in a vehicle to convert a value in time domain, measured by an impact sensor (e.g., a three-axis acceleration sensor) included in the vehicle, into a value in frequency domain, when an impact of greater than or equal to a reference value is applied the vehicle, and detect an impact portion of the vehicle based on a frequency characteristic of the impact to detect the impact portion of the vehicle without an image outside the vehicle, captured by a camera.

The technical problems to be solved by the present inventive concept are not limited to the aforementioned problems, and any other technical problems not mentioned herein will be clearly understood from the following description by those skilled in the art to which the present disclosure pertains.

According to an exemplary embodiment of the present disclosure, an apparatus for detecting an impact portion in a vehicle may include: an impact sensor configured to measure a time domain value which corresponds to an impact applied to the vehicle; and a controller configured to convert the time domain value into a frequency domain value and to detect at least one impact portion of the vehicle based on a frequency characteristic of the impact.

The apparatus may further include a storage device storing a frequency band and an amplitude range for each impact portion of the vehicle. The controller may detect an impact portion corresponding to the converted value in frequency domain based on the frequency band and the amplitude range for each impact portion of the vehicle, the frequency band and the amplitude range being stored in the storage device.

The storage device may store a frequency band and an amplitude range for each impact portion according to a vehicle age. The controller may set a frequency band and an amplitude range for each impact portion in consideration of the vehicle age.

The storage device may store a frequency band and an amplitude range for each impact portion according to a driving distance of the vehicle. The controller may set a frequency band and an amplitude range for each impact portion in consideration of the driving distance of the vehicle.

The apparatus may further include a black box configured to capture an impact image. The controller may set a file name of the impact image by date and time and for each impact portion, and may generate a folder for each impact portion and may separately store an impact image according to the impact portion.

The apparatus may further include a communicator configured to transmit information about the detected impact portion to a smartphone of a user or various display devices in the vehicle.

According to another exemplary embodiment of the present disclosure, a method for detecting an impact portion in a vehicle may include steps of: measuring, by an impact sensor, a time domain value, the value corresponding to an impact applied to the vehicle; converting, by a controller, the time domain value into a frequency domain value; and detecting, by the controller, at least one impact portion of the vehicle based on a frequency characteristic of the impact.

The method may further include storing, by a storage device of the vehicle, a frequency band and an amplitude range for each impact portion of the vehicle. The detecting of the impact portion of the vehicle may include detecting an impact portion corresponding to the converted value in frequency domain based on the frequency band and the amplitude range for each impact portion of the vehicle, the frequency band and the amplitude range being stored in the storage device.

The method may further include storing, by a storage device of the vehicle, a frequency band and an amplitude range for each impact portion according to a vehicle age. The detecting of the impact portion of the vehicle may include setting a frequency band and an amplitude range for each impact portion in consideration of the vehicle age.

The method may further include storing, by a storage device of the vehicle, a frequency band and an amplitude range for each impact portion according to a driving distance of the vehicle. The detecting of the impact portion of the vehicle may include setting a frequency band and an amplitude range for each impact portion in consideration of the driving distance of the vehicle.

The method may further include setting a file name of an impact image by date and time and for each impact portion and generating a folder for each impact portion and separately storing an impact image according to the impact portion.

The method may further include transmitting information about the detected impact portion to a smartphone of a user or various display devices in the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of an apparatus for detecting an impact portion in a vehicle according to an exemplary embodiment of the present disclosure;

FIGS. 2A and 2B are drawings illustrating the result of converting a value in time domain into a value in frequency domain according to an exemplary embodiment of the present disclosure;

FIG. 3 is a drawing illustrating a manner for providing a notification of an impact portion according to an exemplary embodiment of the present disclosure;

FIG. 4 is a flowchart illustrating a method for detecting an impact portion in a vehicle according to an exemplary embodiment of the present disclosure; and

FIG. 5 is a block diagram illustrating a computing system for executing a method for detecting an impact portion in a vehicle according to an exemplary embodiment of the present disclosure.

### DETAILED DESCRIPTION

Hereinafter, exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

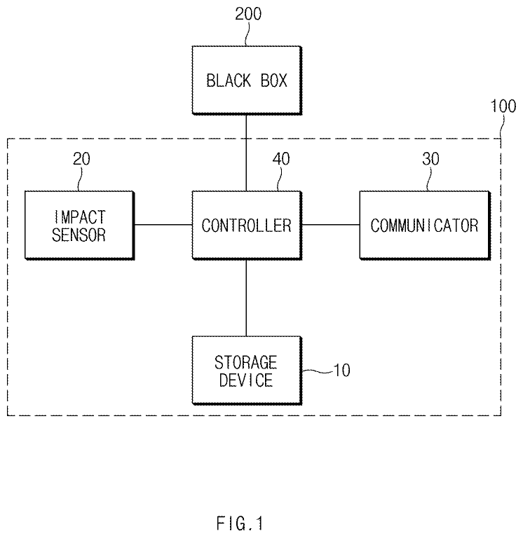

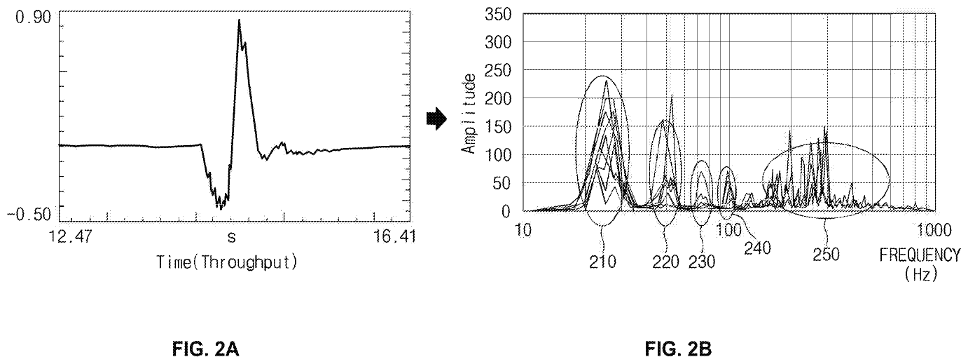

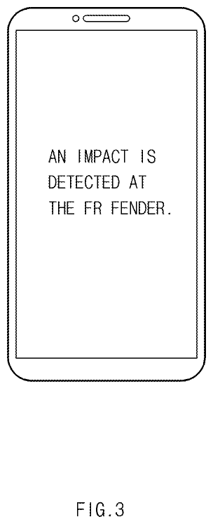

FIG. 1 is a block diagram illustrating a configuration of an apparatus for detecting an impact portion in a vehicle according to an exemplary embodiment of the present disclosure. FIGS. 2A and 2B are drawings illustrating the result of converting a value in time domain into a value in frequency domain according to an exemplary embodiment of the present disclosure. FIG. 3 is a drawing illustrating a manner for providing a notification of an impact portion according to an exemplary embodiment of the present disclosure.

As shown in FIG. 1, an apparatus 100 for detecting an impact portion in a vehicle according to an exemplary embodiment of the present disclosure may include a storage device 10, an impact sensor 20, a communicator 30, and a controller 40. In this case, the respective components may be combined with each other to form one component and some components may be omitted, depending on a manner which executes the apparatus 100 for detecting the impact portion in the vehicle according to an exemplary embodiment of the present disclosure.

Seeing the respective components, first of all, the storage device 10 may store a frequency band and an amplitude range for each impact portion of the vehicle, as reference data used to detect an impact portion of the vehicle. For reference, a designer may apply an impact for each portion of the vehicle to measure a frequency band and an amplitude range in the portion and may store the measured results in the storage device 10. In this case, the designer may perform several experiments and may set a frequency band and an amplitude range of the portion.

Such a frequency band and an amplitude range for each impact portion may be differently set according to a type of the vehicle. The storage device 10 may store reference data corresponding to a type of the vehicle equipped with the apparatus 100 for detecting the impact portion according to an exemplary embodiment of the present disclosure. The impact portion of the vehicle may include, for example, a front bumper, a front left fender, a rear left fender, a front right fender, a rear right fender, a rear bumper, a door of the driver's seat, a door of the passenger seat, a door of the right rear seat, a door of the left rear seat, or the like.

In general, the impact sensor 20 may be implemented as a three-axis (x, y, z) acceleration sensor. The storage device 10 may store a frequency band and an amplitude range for each of three axes for each impact portion of the vehicle. For reference, the value measured by the impact sensor 20 may be a value in time domain, and the value stored in the storage device 10 may be a value in frequency domain.

For example, the storage device 10 may store reference data such as Tables 1 to 3 below for the front left fender. In this case, Table 1 below denotes an x-axis frequency band and an x-axis amplitude range for the front left fender. Table 2 below denotes a y-axis frequency band and a y-axis amplitude range for the front left fender. Table 3 below denotes a z-axis frequency band and a z-axis amplitude range for the front left fender.

TABLE 1

| | x axis | | | | | |
|---|---|---|---|---|---|---|
| | Primary vibration | | Secondary vibration | | Tertiary vibration | |
| | frequency band | | frequency band | | frequency band | |
| Impact | Frequency | Amplitude | Frequency | Amplitude | Frequency | Amplitude |
| portion | band | range | band | range | band | range |
| FL | 80~100 Hz | 90~110 dB | 250~270 Hz | 65~75 dB | 600~620 Hz | 50~55 dB |
| fender | | | | | | |

TABLE 2

| | y axis | | | | | |
|---|---|---|---|---|---|---|
| | Primary vibration | | Secondary vibration | | Tertiary vibration | |
| | frequency band | | frequency band | | frequency band | |
| Impact | Frequency | Amplitude | Frequency | Amplitude | Frequency | Amplitude |
| portion | band | range | band | range | band | range |
| FL | 60~80 Hz | 10~20 dB | 200~220 Hz | 5~15 dB | 620~640 Hz | 0~10 dB |
| fender | | | | | | |

TABLE 3

| | z axis | | | | | |
|---|---|---|---|---|---|---|
| | Primary vibration | | Secondary vibration | | Tertiary vibration | |
| | frequency band | | frequency band | | frequency band | |
| Impact | Frequency | Amplitude | Frequency | Amplitude | Frequency | Amplitude |
| portion | band | range | band | range | band | range |
| FL | 80~100 Hz | 70~80 dB | 250~270 Hz | 40~50 dB | 600~620 Hz | 20~30 dB |
| fender | | | | | | |

For another example, the storage device 10 may store reference data such as Tables 4 to 6 below for the front bumper. In this case, Table 4 below indicates an x-axis frequency band and an x-axis amplitude range for the front bumper. Table 5 below indicates a y-axis frequency band and a y-axis amplitude range for the front bumper. Table 6 below indicates a z-axis frequency band and a z-axis amplitude range for the front bumper.

TABLE 4

| | x axis | | | | | |
|---|---|---|---|---|---|---|
| | Primary vibration | | Secondary vibration | | Tertiary vibration | |
| | frequency band | | frequency band | | frequency band | |
| Impact | Frequency | Amplitude | Frequency | Amplitude | Frequency | Amplitude |
| portion | band | range | band | range | band | range |
| Front | 100~120 Hz | 10~15 dB | 350~370 Hz | 5~10 dB | 800~820 Hz | 0~5 dB |
| bumper | | | | | | |

TABLE 5

| | y axis | | | | | |
|---|---|---|---|---|---|---|
| | Primary vibration | | Secondary vibration | | Tertiary vibration | |
| | frequency band | | frequency band | | frequency band | |
| Impact | Frequency | Amplitude | Frequency | Amplitude | Frequency | Amplitude |
| portion | band | range | band | range | band | range |
| Front | 150~170 Hz | 40~50 dB | 300~320 Hz | 30~40 dB | 600~620 Hz | 10~30 dB |
| bumper | | | | | | |

TABLE 6

| | z axis | | | | | |
|---|---|---|---|---|---|---|
| | Primary vibration | | Secondary vibration | | Tertiary vibration | |
| | frequency band | | frequency band | | frequency band | |
| Impact | Frequency | Amplitude | Frequency | Amplitude | Frequency | Amplitude |
| portion | band | range | band | range | band | range |
| Front | 200~220 Hz | 100~120 dB | 400~420 Hz | 80~90 dB | 750~770 Hz | 70~80 dB |
| bumper | | | | | | |

As described above, an exemplary embodiment is exemplified as only the front left fender and the front bumper for illustrative purposes of the present disclosure. However, embodiments are not limited thereto. For example, the storage device 10 may further store a frequency band and an amplitude range which occur when an impact is applied to above-mentioned respective portions of the vehicle.

When an impact of greater than or equal to a reference value is applied to the vehicle, the storage device 10 may store various logics, algorithms, and programs required in a process of converting a value in time domain, measured by an impact sensor (e.g., a three-axis acceleration sensor) included in the vehicle, into a value in frequency domain and detecting an impact portion of the vehicle based on a frequency characteristic of the impact.

In addition, the storage device 10 may further store frequency bands and amplitude ranges for three axes for each impact portion according to a vehicle age. In other words, the storage device 10 may store frequency bands and amplitude ranges for three axes for each impact portion of the vehicle, per vehicle age. For example, the storage device 10 may store frequency bands and amplitude ranges for three axes for each impact portion of the vehicle at intervals of one year, three years, or five years from a first year to a twentieth year. In this case, the unit years may be randomly set according to the intention of the designer.

Furthermore, the storage device 10 may further store frequency bands and amplitude ranges for each of three axes for each impact portion according to a driving distance of the vehicle. In this case, the driving distance of the vehicle may be calculated by an odometer. For example, the storage device 10 may store frequency bands and amplitude ranges for three axes for each impact portion of the vehicle at intervals of 10,000 km, 30,000 km, or 50,000 km in a driving distance from 0 km to 200,000 km. Here, the unit kilometers may be randomly set according to the intention of the designer.

Furthermore, the storage device 10 may include at least one type of storage medium, such as a flash memory type memory, a hard disk type memory, a micro type memory, a card type memory (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, and an optical disk.

The impact sensor 20 may be implemented as a three-axis acceleration sensor (also called a G sensor). The impact sensor 20 may be mounted at a specific position of the vehicle to measure a value corresponding to an impact applied to each portion of the vehicle. In this case, the impact sensor 20 may output a measured value in time domain.

The communicator 30 may transmit an impact image, information indicating whether an impact occurs, a time when the impact occurs, an impact portion, or the like to a smartphone of the user or a display device (e.g., an audio video navigation (AVN) system, a cluster, or the like) in the vehicle under control of the controller 40. In this case, the impact image may be an image captured by a black box 200 (an image recording device) loaded into the vehicle. The black box 200 may include a first camera which captures an image in front of the vehicle and a second camera which captures an image behind the vehicle.

Such a communicator 20 may include at least one or more of a mobile communication module, a wireless Internet module, and a short-range communication module.

Herein, the mobile communication module may transmit and receive a wireless signal with an autonomous vehicle, a service server, or the like over a mobile communication network which is established according to a technical standard or a communication mode for mobile communication (e.g., global system for mobile communication (GSM), code division multiple access (CDMA), code division multiple access 200 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), LTE-advanced (LTE-A), or the like).

The wireless Internet module may be a module for accessing a wireless Internet and may transmit and receive a wireless signal with the autonomous vehicle, the service server, or the like over wireless local area network (WLAN), wireless-fidelity (Wi-Fi), Wi-Fi Direct, digital living network alliance (DLNA), wireless broadband (WiBro), world interoperability for microwave access (WiMAX), high speed downlink packet access (HSDPA), high speed uplink packet access (HSUPA), long term evolution (LTE), LTE-advanced (LTE-A), or the like.

The short-range communication module may support the short-range communication using at least one of Bluetooth™, radio frequency identification (RFID), infrared data association (IrDA), ultra wideband (UWB), ZigBee, near field communication (NFC), and wireless universal serial bus (USB) technologies.

The controller 40 may perform overall control such that the respective components normally perform their own functions. Such a controller 40 may be implemented in the form of hardware or software or in the form of a combination thereof. The controller 40 may be implemented as, but not limited to, a microprocessor.

When the impact of greater than or equal to the reference value is applied to the vehicle, the controller 40 may perform a variety of control in the process of converting a value in time domain, measured by the impact sensor 20 included in the vehicle, into a value in frequency domain and detecting an impact portion of the vehicle based on a frequency characteristic of the impact. Herein, the reference value may be a value used to determine whether an impact occurs by the black box 200 which is generally well known.

The controller 40 may perform fast Fourier transform (FFT) to convert the value in time domain, measured by the impact sensor 20, into the value in frequency domain.

FIG. 2A illustrates a value in time domain, measured by the impact sensor 20. FIG. 2B illustrates a value in frequency domain. In this case, in FIG. 2B, the x-axis indicates a frequency band and the y-axis indicates an amplitude range.

In FIG. 2B, reference numeral 210 indicates a primary vibration frequency band and an amplitude range. Reference numeral 220 indicates a secondary vibration frequency band and an amplitude range. Reference numeral 230 indicates a tertiary vibration frequency band and an amplitude range. Reference numeral 240 indicates a quaternary vibration frequency band and an amplitude range. Reference numeral 250 indicates a vibration frequency band and an amplitude range by noise. In this case, in an exemplary embodiment of the present disclosure, the primary vibration frequency band and the amplitude range, the secondary vibration frequency band and the amplitude range, and the tertiary vibration frequency band and the amplitude range are set as valid data, and reference numerals 240 and 250 are disregarded.

The controller 40 may determine an impact portion corresponding to the converted value in frequency domain based on the frequency band and the amplitude range for each impact portion of the vehicle, stored in the storage device 10. In this case, the controller 40 may use the similarity determination technique which is generally well known in a process of comparing reference data with measured data.

The controller 40 may control the communicator 30 to transmit information about the determined impact portion to a smartphone of a user or various display devices in the vehicle. For example, FIG. 3 illustrates information displayed on the smartphone.

Furthermore, when reference data according to a vehicle age (e.g., frequency bands and amplitude ranges for three axes for each impact portion) is further stored in the storage device 10, the controller 40 may set the reference data depending on the vehicle age.

When reference data according to a driving distance of the vehicle (e.g., frequency bands and amplitude ranges for three axes for each impact portion) is further stored in the storage device 10, the controller 40 may set the reference data depending on the driving distance of the vehicle.

The controller 40 may set a file name of an impact image by date and time and for each impact portion. For example, the file name is “190219_105530_RFfender”. Herein, the first 6-digit number indicates year/month/day, the next 6-digit number indicates hour/minute/second, and the FRfender indicates an impact portion.

Furthermore, the controller 40 may generate a folder for each impact portion and may separately store an impact image according to an impact portion. In this case, the impact image may be stored in a memory of the black box 200 and may be stored in the storage device 10.

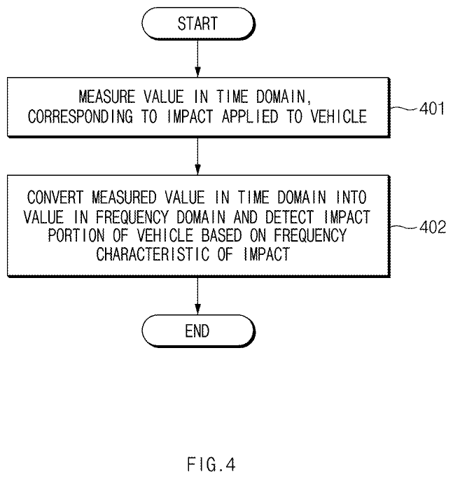

FIG. 4 is a flowchart illustrating a method for detecting an impact portion in a vehicle according to an exemplary embodiment of the present disclosure.

First of all, in operation 401, an impact sensor 20 of FIG. 1 may measure a value in time domain, corresponding to an impact applied to the vehicle.

In operation 402, a controller 40 of FIG. 1 may convert the measured value in time domain into a value in frequency domain and may detect an impact portion of the vehicle based on a frequency characteristic of the impact. In this case, the controller 40 may perform the process of detecting the impact portion when the impact applied to the vehicle is greater than or equal to a reference value.

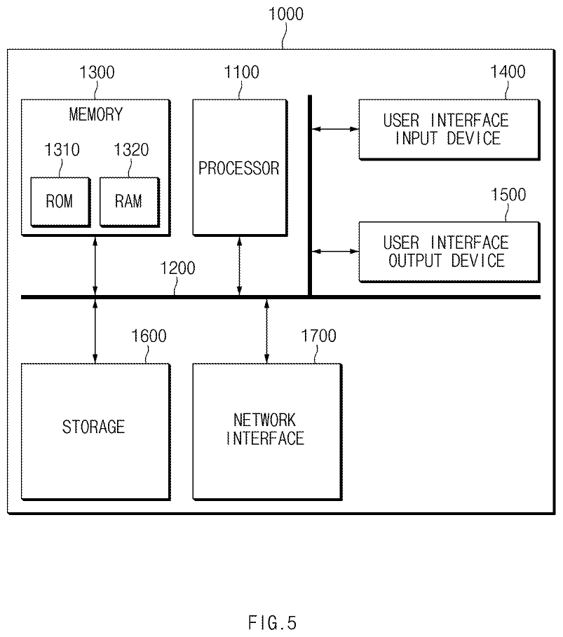

FIG. 5 is a block diagram illustrating a computing system for executing a method for detecting an impact portion in a vehicle according to an exemplary embodiment of the present disclosure.

Referring to FIG. 5, the method for detecting the impact portion in the vehicle according to an exemplary embodiment of the present disclosure may be implemented by means of the computing system. A computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM memory, a flash memory, a ROM memory, an EPROM memory, an EEPROM memory, a register, a hard disk, a removable disk, a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

The apparatus and method for detecting the impact portion in the vehicle according to an exemplary embodiment of the present disclosure may convert a value in time domain, measured by the impact sensor (e.g., the three-axis acceleration sensor) included in the vehicle, into a value in frequency domain, when the impact of greater than or equal to the reference value is applied the vehicle, and may detect the impact portion of the vehicle based on the frequency characteristic of the impact to detect the impact portion of the vehicle without an image outside the vehicle, captured by the camera.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. An apparatus for detecting an impact portion in a vehicle, the apparatus comprising:
an impact sensor configured to measure a time domain value which corresponds to an impact applied to the vehicle; and
a controller configured to:
convert the time domain value into a frequency domain value, and
detect at least one impact portion of the vehicle based on a frequency characteristic of the impact.

2. The apparatus of claim 1, further comprising:
a storage device storing a frequency band and an amplitude range for each impact portion of the vehicle.

3. The apparatus of claim 2, wherein the controller is configured to:
detect the impact portion corresponding to the frequency domain value based on the frequency band and the amplitude range for each impact portion of the vehicle.

4. The apparatus of claim 2, wherein the storage device stores a frequency band and an amplitude range for each impact portion according to a model year of the vehicle.

5. The apparatus of claim 4, wherein the controller is configured to:
set the frequency band and the amplitude range for each impact portion in consideration of the model year of the vehicle.

6. The apparatus of claim 2, wherein the storage device stores a frequency band and an amplitude range for each impact portion according to a driving distance of the vehicle.

7. The apparatus of claim 6, wherein the controller is configured to:
set the frequency band and the amplitude range for each impact portion in consideration of the driving distance of the vehicle.

8. The apparatus of claim 1, further comprising:
a black box configured to capture at least one impact image.

9. The apparatus of claim 8, wherein the controller is configured to:
set a file name of the at least one impact image by date and time and for each impact portion.

10. The apparatus of claim 9, wherein the controller is configured to:
generate a folder for each impact portion; and
separately store the at least one impact image according to the impact portion.

11. The apparatus of claim 1, further comprising:
a communicator configured to transmit information about the at least one impact portion to a smartphone of a user or various display devices in the vehicle.

12. A method for detecting an impact portion in a vehicle, the method comprising steps of:
measuring, by an impact sensor, a time domain value which corresponds to an impact applied to the vehicle;
converting, by a controller, the time domain value into a frequency domain value; and
detecting, by the controller, at least one impact portion of the vehicle based on a frequency characteristic of the impact.

13. The method of claim 12, further comprising a step of:
storing, by a storage device, a frequency band and an amplitude range for each impact portion of the vehicle.

14. The method of claim 13, wherein the step of detecting at least one impact portion of the vehicle includes:
detecting an impact portion corresponding to the frequency domain value based on the frequency band and the amplitude range for each impact portion of the vehicle.

15. The method of claim 12, further comprising a step of:
storing, by a storage device, a frequency band and an amplitude range for each impact portion according to a model year of the vehicle.

16. The method of claim 15, wherein the step of detecting at least one impact portion of the vehicle includes:
setting the frequency band and the amplitude range for each impact portion in consideration of the model year of the vehicle.

17. The method of claim 12, further comprising a step of:
storing, by a storage device, a frequency band and an amplitude range for each impact portion according to a driving distance of the vehicle.

18. The method of claim 17, wherein the step of detecting at least one impact portion of the vehicle includes:
setting the frequency band and the amplitude range for each impact portion in consideration of the driving distance of the vehicle.

19. The method of claim 12, further comprising steps of:
setting a file name of an impact image by date and time and for each impact portion; and
generating a folder for each impact portion and separately storing the impact image according to the impact portion.

20. The method of claim 12, further comprising a step of:
transmitting information about the impact portion to a smartphone of a user or various display devices in the vehicle.
